(19) United States
(12) Patent Application Publication
(10) Pub. No.: US 2021/0199948 A1
(43) Pub. Date: Jul. 1, 2021

(54) ELECTROWETTING DEVICE

(71) Applicant: SHARP KABUSHIKI KAISHA, Sakai City (JP)

(72) Inventors: TOMOHIRO KOSAKA, Sakai City (JP); JUXIAN LI, Sakai City (JP); KEI IKUTA, Yonago-shi (JP)

(21) Appl. No.: 17/132,935

(22) Filed: Dec. 23, 2020

Related U.S. Application Data
(60) Provisional application No. 62/954,977, filed on Dec. 30, 2019.

(51) Int. Cl. G02B 26/00

(52) U.S. Cl. CPC G02B 26/005

(57) ABSTRACT

An electrowetting device of the present disclosure includes: an electrode substrate including a first substrate, a plurality of first electrodes formed above the first substrate, a dielectric layer formed on the first electrodes, and a first hydrophobic layer formed on the dielectric layer; a counter substrate disposed across a predetermined clearance from the electrode substrate, and including a second substrate, a second electrode formed on the second substrate, and a second hydrophobic layer formed on the second electrode; and a seal attaching the electrode substrate and the counter substrate together, and defining the predetermined clearance between the first hydrophobic layer and the second hydrophobic layer.

### CROSS-REFERENCE TO RELATED APPLICATION

The present application claims priority to U.S. Provisional Application Ser. No. 62/954,977, filed Dec. 30, 2019, the content to which is hereby incorporated by reference into this application.

### BACKGROUND OF THE INVENTION

### 1. Field of the Invention

The present disclosure relates to an electrowetting device.

### 2. Description of the Related Art

In recent years, electrowetting devices (also referred to as microfluidic devices or droplet devices) are being developed. When an electric field is applied to a droplet on a hydrophobic dielectric layer provided on an electrode, a contact angle of the droplet with respect to the dielectric layer changes. This phenomenon is referred to as the electrowetting. The electrowetting makes it possible to control a micro droplet by, for example, the sub-microliter volume. Electrowetting devices, often referred to as electrowetting on dielectric devices (EWODs), may hereinafter be abbreviated to EWODs for the sake of simplicity.

Japanese Unexamined Patent Application Publication No. 2015-022104 discloses an electrowetting device including: a pair of substrates; and a partitioning wall partitioning a liquid for each of the cell regions. For example, one of the substrates is provided with: a first region that is hydrophobic; and a second region (a hydrophilic region) that is less hydrophobic than the first region. The partitioning wall is formed in the second region. Such a structure contributes to improvement in stability and reliability of the partitioning wall.

The substrates are attached together to face each other using a sealing material, with a predetermined clearance (also referred to as a “cell”) provided therebetween for filling a liquid. The sealing material is applied to a sealing region of the substrates using, for example, a dispenser.

The inventors have studied the electrowetting device and found out that, when the sealing material is applied to the hydrophilic sealing region, the position and discharge amount of the sealing material vary in the sealing region, depending on the precision of the dispenser. As a result, the sealing material would be excessively or insufficiently provided locally to the sealing region. The local variation of the sealing material makes the sealing position in the cell unstable. As a result, the volume inside the cell (an active area) is not constant and can vary. In particular, in a case where the volume of the active area is required to be precise, the variation in volume could adversely affect performance of the electrowetting device. Even if the sealing material is applied to the hydrophilic sealing region disclosed in Japanese Unexamined Patent Application Publication No. 2015-022104, the problems affecting the performance cannot be overcome.

An aspect of the present invention is conceived in view of the above problems, and intended to provide an electrowetting device in which local variation of a sealing material is reduced in a sealing region, so that the electrowetting device can improve in performance.

### Solution to Problem

The Specification discloses an electrowetting device according to the items below.

### [Item 1]

An electrowetting device includes: an electrode substrate including a first substrate, a plurality of first electrodes formed above the first substrate, a dielectric layer formed on the first electrodes, and a first hydrophobic layer formed on the dielectric layer, a counter substrate disposed across a predetermined clearance from the electrode substrate, and including a second substrate, a second electrode formed on the second substrate, and a second hydrophobic layer formed on the second electrode; and a seal attaching the electrode substrate and the counter substrate together, and defining the predetermined clearance between the first hydrophobic layer and the second hydrophobic layer. The electrode substrate and the counter substrate each include a sealing region having a predetermined width and surrounding the first hydrophobic layer and the second hydrophobic layer when observed from a normal direction of the electrode substrate and the counter substrate. The seal is formed along the sealing region of each of the electrode substrate and the counter substrate. The sealing region of at least one of the electrode substrate and the counter substrate includes a hydrophobic angled region having a wettability gradient along the predetermined width of the sealing region and a width of a hydrophilic region. The wettability gradient increases in hydrophobicity toward an outer edge of the sealing region.

### [Item 2]

In the electrowetting device according to Item 1, the hydrophobic angled region includes a hydrophilic surface hydrophobicity of which is relatively low, and a hydrophobic surface hydrophobicity of which is relatively high. A proportion of the hydrophilic surface per unit of area, in a direction perpendicular to the predetermined width of the sealing region, decreases toward the outer edge of the sealing region.

### [Item 3]

In the electrowetting device according to Item 2, when observed from the normal direction of the electrode substrate and the counter substrate, the hydrophilic surface is shaped into a comb in the hydrophobic angled region to taper toward the outer edge of the sealing region.

### [Item 4]

In the electrowetting device according to Item 2, when observed from the normal direction of the electrode substrate and the counter substrate, the hydrophilic surface is shaped into dots in the hydrophobic angled region.

### [Item 5]

In the electrowetting device according to any one of Items 1 to 4, when observed from the normal direction of the electrode substrate and the counter substrate, the hydrophobic angled region is in contact with the outer edge of the scaling region.

### [Item 6]

In the electrowetting device according to Item 5, when observed from the normal direction of the electrode substrate and the counter substrate, the hydrophobic angled region is further in contact with the hydrophilic region. The hydrophobic angled region has the wettability gradient increasing in hydrophobicity from a boundary with the hydrophilic region toward the outer edge of the sealing region.

### [Item 7]

In the electrowetting device according to Item 6, the hydrophobic angled region has the wettability gradient continuously increasing in hydrophobicity from the boundary with the hydrophilic region toward the outer edge of the sealing region.

### [Item 8]

In the electrowetting device according to Item 6 or Item 7, the hydrophilic region is in contact with an inner edge of the sealing region.

### [Item 9]

In the electrowetting device according to Item 8, the hydrophobic angled region has a width along the predetermined width of the sealing region. The width is greater than or equal to half, and smaller than or equal to two third, the predetermined width of all the sealing region.

### [Item 10]

In the electrowetting device according to Item 6 or Item 7, the sealing region includes an other hydrophobic angled region different from the hydrophobic angled region. The other hydrophobic angled region is in contact with an inner edge and with the hydrophilic region of the sealing region. The other hydrophobic angled region has a wettability gradient along the predetermined width of the sealing region. The wettability gradient increases in hydrophobicity toward the inner edge of the sealing region.

### [Item 11]

In the electrowetting device according to Item 10, the wettability gradient of the other hydrophilic angled region is larger than the wettability gradient of the hydrophobic angled region.

### [Item 12]

In the electrowetting device according to any one of Items 6 to 11, the sealing region of the counter substrate includes the hydrophilic region and the hydrophobic angled region. The hydrophobic angled region in the outer edge of the sealing region is substantially equal in hydrophobicity to the second hydrophobic layer.

### [Item 13]

In the electrowetting device according to Item 12 depending from Item 10, the other hydrophobic angled region in the inner edge of the sealing region is substantially equal in hydrophobicity to the second hydrophobic layer.

### [Item 14]

In the electrowetting device according to any one of Items 1 to 13, the first electrodes are a group of electrodes arranged in a matrix. The electrode substrate further includes a plurality of thin-film transistors (TFTs) connected to the first electrodes.

An aspect of the present invention provides an electrowetting device in which local variation of a sealing material is reduced in a sealing region, so that the electrowetting device can improve in performance.

### BRIEF DESCRIPTION OF THE DRAWINGS

FIG. 1 is a perspective view schematically illustrating an overall configuration of an AM-EWOD 100.

FIG. 2 is a cross-sectional view schematically and mainly illustrating an internal cross-section of the AM-EWOD 100.

FIG. 3 is a plan view schematically illustrating a layout of electrodes and a drive circuit provided on a thin-film transistor (TFT) substrate 10, when observed from the normal direction of the TFT substrate 10.

FIG. 4 is a plan view schematically illustrating a layout of a hydrophobic layer 24 and a seal 50 provided on a counter substrate 20 when observed from the normal direction of the counter substrate 20.

FIG. 5 is a plan view schematically illustrating the seal 50 formed in a sealing region 51 of the counter substrate 20.

FIG. 6 is a drawing illustrating the sealing region 51 including a hydrophilic region 60A and a hydrophobic angled region 60B.

FIG. 7A is a drawing illustrating how a position in which a sealing material is applied can be controlled with the hydrophobic angled region 60B provided in the sealing region 51.

FIG. 7B is a drawing illustrating how the position in which the sealing material applied can be controlled with the hydrophobic angled region 60B provided in the sealing region 51.

FIG. 7C is a drawing illustrating how the position in which the sealing material is applied can be controlled with the hydrophobic angled region 60B provided in the sealing region 51.

FIG. 7D is a drawing illustrating how the position in which the sealing material is applied can be controlled with the hydrophobic angled region 60B provided in the sealing region 51.

FIG. 8 is a drawing illustrating a wettability gradient of a sealing region according to a comparative example.

FIG. 9A is a drawing illustrating a position in which a sealing material is applied according to the comparative example when the sealing material is discharged in small amount.

FIG. 9B is a drawing illustrating the position in which the sealing material is applied according to the comparative example when the sealing material is discharged in small amount.

FIG. 9C is a drawing illustrating the position in which the sealing material is applied according to the comparative example when the sealing material is discharged in small amount.

FIG. 10A is a drawing illustrating a position in which a sealing material is applied according to the comparative example when the sealing material is discharged in large amount.

FIG. 10B is a drawing illustrating the position in which the sealing material is applied according to the comparative example when the sealing material is discharged in large amount.

FIG. 10C is a drawing illustrating the position in which the sealing material is applied according to the comparative example when the sealing material is discharged in large amount.

FIG. 11 is a drawing illustrating a wettability gradient of the sealing region 51 according to this embodiment.

FIG. 12A is a drawing illustrating a position in which a sealing material is applied when the sealing material is discharged in small amount.

FIG. 12B is a drawing illustrating the position in which the sealing material is applied when the sealing material is discharged in small amount.

FIG. 12C is a drawing illustrating the position in which the sealing material is applied when the sealing material is discharged in small amount.

FIG. 12D is a drawing illustrating the position in which the sealing material is applied when the sealing material is discharged in small amount.

FIG. 13A is a drawing illustrating a position in which a sealing material is applied when the sealing material is discharged in large amount.

FIG. 13B is a drawing illustrating the position in which the sealing material is applied when the sealing material is discharged in large amount.

FIG. 13C is a drawing illustrating the position in which the sealing material is applied when the sealing material is discharged in large amount.

FIG. 13D is a drawing illustrating the position in which the sealing material is applied when the sealing material is discharged in large amount.

FIG. 14 is a drawing illustrating a wettability gradient of the sealing region 51 including an other hydrophobic angled region 60C different from the hydrophobic angled region 60B.

FIG. 15A is a schematic view illustrating a principle of how the electrowetting can move a droplet 42.

FIG. 15B is a schematic view illustrating the principle of how the electrowetting can move the droplet 42.

FIG. 15C is a schematic view illustrating the principle of how the electrowetting can move the droplet 42.

FIG. 16A is a cross-sectional view schematically illustrating an example of a method for manufacturing the TFT substrate 10 included in the AM-EWOD 100.

FIG. 16B is a cross-sectional view schematically illustrating the example of the method for manufacturing the TFT substrate 10 included in the AM-EWOD 100.

FIG. 16C is a cross-sectional view schematically illustrating the example of the method for manufacturing the TFT substrate 10 included in the AM-EWOD 100.

FIG. 16D is a cross-sectional view schematically illustrating the example of the method for manufacturing the TFT substrate 10 included in the AM-EWOD 100.

FIG. 16E is a cross-sectional view schematically illustrating the example of the method for manufacturing the TFT substrate 10 included in the AM-EWOD 100.

FIG. 16F is a cross-sectional view schematically illustrating the example of the method for manufacturing the TFT substrate 10 included in the AM-EWOD 100.

FIG. 16G is a cross-sectional view schematically illustrating the example of the method for manufacturing the TFT substrate 10 included in the AM-EWOD 100.

FIG. 17A is a cross-sectional view schematically illustrating an example of a method for manufacturing the counter substrate 20 included in the AM-EWOD 100.

FIG. 17B is a cross-sectional view schematically illustrating the example of the method for manufacturing the counter substrate 20 included in the AM-EWOD 100.

FIG. 17C is a cross-sectional view schematically illustrating the example of the method for manufacturing the counter substrate 20 included in the AM-EWOD 100.

FIG. 17D is a cross-sectional view schematically illustrating an example of a manufacturing method in which the TFT substrate 10 and the counter substrate 20 are attached together.

### DETAILED DESCRIPTION OF THE INVENTION

In a non-limiting and exemplary embodiment, an electrowetting device according to the present invention includes: an electrode substrate including a first substrate, a plurality of first electrodes formed above the first substrate, a dielectric layer formed on the first electrodes, and a first hydrophobic layer formed on the dielectric layer; a counter substrate disposed across a predetermined clearance from the electrode substrate, and including a second substrate, a second electrode formed on the second substrate, and a second hydrophobic layer formed on the second electrode; and a seal attaching the electrode substrate and the counter substrate together, and defining the predetermined clearance between the first hydrophobic layer and the second hydrophobic layer. The electrode substrate and the counter substrate each include a sealing region having a predetermined width and surrounding the first hydrophobic layer and the second hydrophobic layer when observed from a normal direction of the electrode substrate and the counter substrate. The seal is formed in the sealing region of each of the electrode substrate and the counter substrate. The sealing region of at least one of the electrode substrate and the counter substrate includes a hydrophobic angled region having a wettability gradient along the predetermined width of the sealing region and a width of a hydrophilic region. The wettability gradient increases in hydrophobicity toward an outer edge of the sealing region.

A typical example of the electrowetting device is of an active-matrix type. Described hereinafter as an example is an active-matrix electrowetting device (AM-EWOD). The electrowetting device in an embodiment of the present invention, however, shall not be limited to such an example.

In the AM-EWOD, an electrode substrate is an active-matrix substrate including a plurality of thin-film transistors (TFTs). Hereinafter, the active-matrix substrate (or the electrode substrate) is referred to as a “TFT substrate.” Moreover, in this Specification, the terms “sealing material” and “seal” formed of the sealing material may interchangeably be used. The term “seal” is used to mainly describe a structure of a device, and the term “sealing material” is used to mainly describe a method for manufacturing the device.

Described below is an embodiment of the present invention, with reference to the attached drawings. Note that descriptions more than necessary may be omitted. Examples of descriptions to be omitted include detailed descriptions of well-known issues and overlapping descriptions of substantially identical features. This is to keep the descriptions below from redundancy, and encourage those skilled in the art to understand the embodiment readily. The inventor of the present invention provides the descriptions below and the drawings attached thereto in order for those skilled in the art to sufficiently understand the present disclosure. The descriptions and the drawings are not intended to limit the subject matter of claims. Like reference signs designate identical or corresponding components throughout the descriptions below.

### Embodiment

1. Structure of AM-EWOD 100

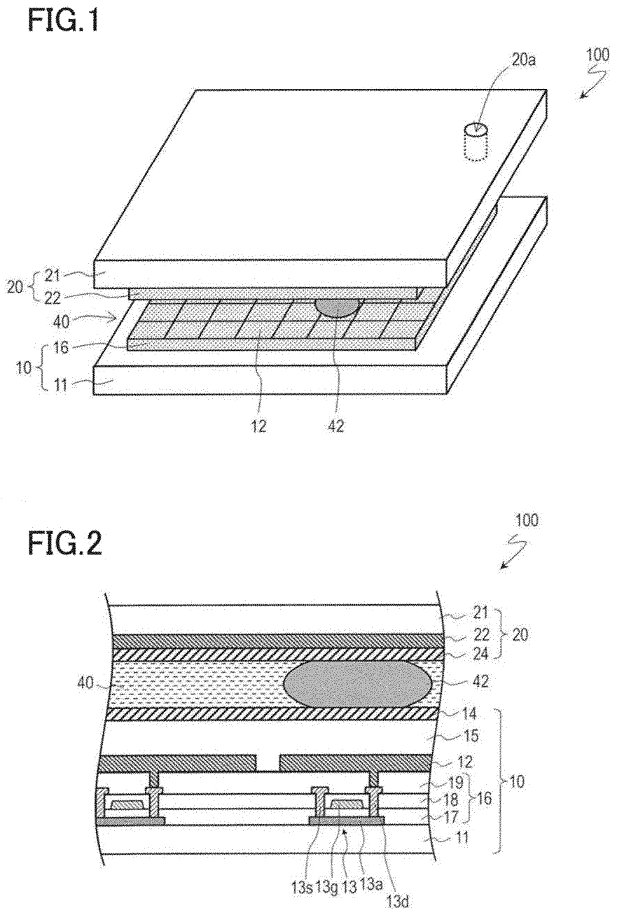

Described below is a structure of an AM-EWOD 100 according to this embodiment, with reference to FIGS. 1 to 4.

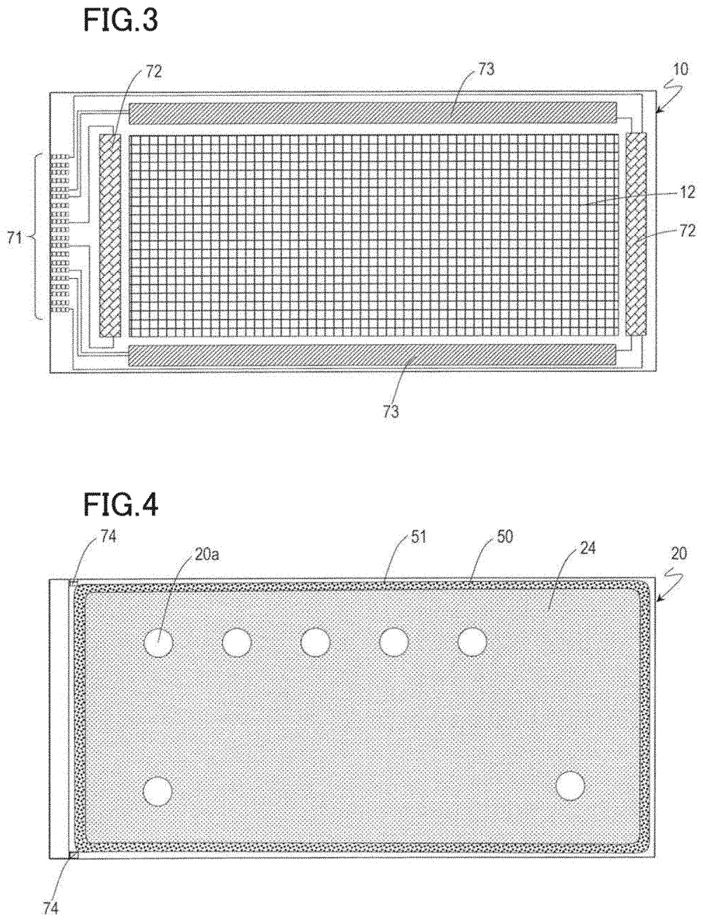

FIG. 1 is a perspective view schematically illustrating an overall configuration of the AM-EWOD 100. FIG. 2 is a cross-sectional view schematically and mainly illustrating an internal cross-section of the AM-EWOD 100. FIG. 3 is a plan view schematically illustrating a layout of electrodes and a drive circuit provided on a TFT substrate 10, when observed from the normal direction of the TFT substrate 10. FIG. 4 is a plan view schematically illustrating a layout of a hydrophobic layer 24 and a seal 50 provided on a counter substrate 20 when observed from the normal direction of the counter substrate 20.

As illustrated in FIGS. 1 and 2, the AM-EWOD 100 includes: the TFT substrate 10; and the counter substrate 20. The counter substrate 20 is disposed across a predetermined clearance 40 from the TFT substrate 10.

The TFT substrate 10 includes: a substrate 11; a plurality of first electrodes 12; a plurality of TFTs 13; a first hydrophobic layer 14; and a dielectric layer 15. The substrate 11 is, for example, a glass substrate.

The first electrodes 12 are provided above (i.e., supported by) the substrate 11. The first electrodes 12 are arranged in a matrix. The first electrodes 12 are connected to a thin-film electronic circuit (a TFT circuit) 16 including the TFTs 13. Each of the first electrodes 12 can be independently supplied with a voltage. Hereinafter, each of the first electrodes 12 is referred to as “a unit electrode.” The unit electrode 12 is formed of, for example, indium tin oxide (ITO).

Each of the TFTs 13 is connected to a corresponding one of the unit electrodes 12. Each TFT 13 includes: a semiconductor layer 13a; a gate electrode 13g; a source 13s; and a drain electrode 13d. The semiconductor layer 13a can be formed of various known semiconductor materials. The TFT 13 illustrated in FIG. 2 as an example is of a top-gate structure. Alternatively, the TFT 13 may be of a bottom-gate structure.

The semiconductor layer 13a is formed on the substrate 11. The semiconductor layer 13a is covered with a gate insulating layer 17. The gate insulating layer 17 is, for example, an SiN layer, an SiO₂ layer, or a multilayer including an SiN layer and an SiO₂ layer. On the gate insulating layer 17, the gate electrode 13g is formed. The gate electrode 13g is covered with an interlayer insulating layer 18. The interlayer insulating layer 18 is, for example, an SiN layer, an SiO₂ layer, or a multilayer including an SiN layer and SiO₂ layer. On the interlayer insulating layer 18, the source electrode 13s and the drain electrode 13d are formed. The source electrode 13s and the drain electrode 13d are connected to the semiconductor layer 13a through contact holes formed in the gate insulating layer 17 and the interlayer insulating layer 18.

The TFT 13 is covered with an interlayer insulating layer 19. The interlayer insulating layer 19 is formed of, for example, a photosensitive resin material. The unit electrode 12 is formed on the interlayer insulating layer 19. The unit electrode 12 is connected to the drain electrode 13d through a contact hole formed in the interlayer insulating layer 19.

The dielectric layer 15 is provided on the unit electrodes 12. The first hydrophobic layer 14 is provided above the unit electrodes 12 through the dielectric layer 15. In other words, the dielectric layer 15 is provided between the unit electrodes 12 and the first hydrophobic layer 14. The dielectric layer 15 is, for example, an SiN layer ranging from 100 nm to 500 nm in thickness. The first hydrophobic layer 14 is, for example, a fluoropolymer layer ranging from 30 nm to 100 nm in thickness.

As illustrated in FIG. 3, the TFT substrate 10 has an edge region surrounding an electrode region in which the unit electrodes 12 are arranged in a matrix. Disposed in the edge region are an on-board terminal 71, a gate driver 72, and a source driver 73. The on-board terminal 71 supplies a control signal, needed to control the TFT circuit 16, from an external drive circuit (not shown) to the gate driver 72 and the source driver 73.

The gate driver 72 is connected through a plurality of select lines in rows (not shown) to the gate electrode 13g of each of the TFTs 13. In accordance with the control signal to be supplied from the external drive circuit, the gate driver 72 supplies a select signal to a TFT 13 in a selected row. The source driver 73 is connected through a plurality of write lines in columns (not shown) to the source electrode 13s of each of the TFTs 13. In accordance with the control signal to be supplied from the external drive circuit, the source driver 73 supplies a write signal to a TFT 13 in a column to be written in.

The counter substrate 20 includes: a substrate 21; a second electrode 22; and a second hydrophobic layer 24. The substrate 21 is, for example, a glass substrate.

The second electrode 22 is provided on (i.e., supported by) the substrate 21. The second electrode 22 is disposed across from the unit electrodes 12. Hereinafter, the second electrode 22 is referred to as a “counter electrode.” The counter electrode 22 is formed of, for example, ITO. The dielectric layer 22 has a thickness ranging from 50 nm to 150 nm, for example. The second hydrophobic layer 24 is provided on the counter electrode 22. The second hydrophobic layer 24 is, for example, a fluoropolymer layer ranging from 30 nm to 100 nm in thickness.

As illustrated in FIG. 4, the counter substrate 20 includes a sealing region 51 having a predetermined width, and surrounding the second hydrophobic layer 24 when observed from the normal direction of the counter substrate 20. The seal 50 is formed along the sealing region 51. Even though not shown in FIG. 3, the TFT substrate 10 includes, as the counter substrate 20 includes, a sealing region (not shown) having a predetermined width, and surrounding the first hydrophobic layer 14 (or the electrode region) when observed from the normal direction of the TFT substrate 10. The seal 50 is formed along the sealing region. In other words, the seal 50 is positioned in the sealing regions of the TFT substrate 10 and the counter substrate 20.

The seal 50 attaches the TFT substrate 10 and the counter substrate 20 together, and defines the clearance 40 between the first hydrophobic layer 14 and the second hydrophobic layer 24. The second hydrophobic layer 24 is typically the same in design as the first hydrophobic layer 14 of the TFT substrate 10. Alternatively, the second hydrophobic layer 24 and the first hydrophobic layer 14 may be different in design. Moreover, the counter substrate 20 includes a through hole 20a for injecting a droplet into the clearance 40. The through hole 20a can be a single hole, or include two or more holes. The size, position and number of the through holes 20a may be appropriately determined on the basis of the product specifications of an EWOD.

As illustrated in FIG. 4, the counter electrode 22 has an edge region provided with a transfer (a transfer electrode) 74 for electrically connecting the counter electrode 22 to the on-board terminal 71 of the TFT substrate 10. The transfer 74 can be formed of, for example, a conductive paste.

The clearance (or a flow passage) 40 formed between the TFT substrate 10 and the counter substrate 20 contains a droplet 42. The droplet 42 may be a single droplet, or include two or more droplets. The droplet 42 is injected from the through hole 20a formed in the counter substrate 20. Used as the droplet 42 is a conductive liquid including an ionic liquid or a polar liquid. Examples of the droplet 42 include water, electrolytic solution (electrolyte aqueous solution), alcohols, and various ionic liquids. Examples of such liquids include: a whole blood sample, a bacterial cell suspension; protein or antibody solution; and various buffer solutions.

Injected into the clearance 40 may be a non-conductive liquid not to be mixed with the droplet 42. For example, the space in the clearance 40 other than the droplet 42 may be filled with the non-conductive liquid. The non-conductive liquid is injected from the through hole 20a before the droplet 42 is injected. Used as the non-conductive liquid may be a non-polar liquid (a non-ionic liquid) whose surface tension is lower than that of the droplet 42. An example of the non-conductive liquid includes: a hydrocarbon-based solvent (a low-molecular hydrocarbon-based solvent) such as decane, dodecane, hexadecane, and undecane; an oil such as silicone oil; or a fluorocarbon-based solvent. An example of the silicone oil includes dimethylpolysiloxane. The non-conductive liquid may be of a single kind, or of a combination of several kinds of such liquids mixed together as appropriate. The non-conductive liquid to be selected is smaller in specific gravity than the droplet 42. The specific gravities of the droplet 42 and the non-conductive liquid shall not be limited in particular to specific ones as long as the specific gravity of the non-conductive liquid is smaller than that of the droplet 42. For example, when the droplet 42 is an electrolyte aqueous solution, the specific gravity of the droplet 42 is nearly equal to that of water (≈1.0). An example of the non-conductive liquid includes a liquid, such as silicone oil, whose specific gravity is smaller than 1.0.

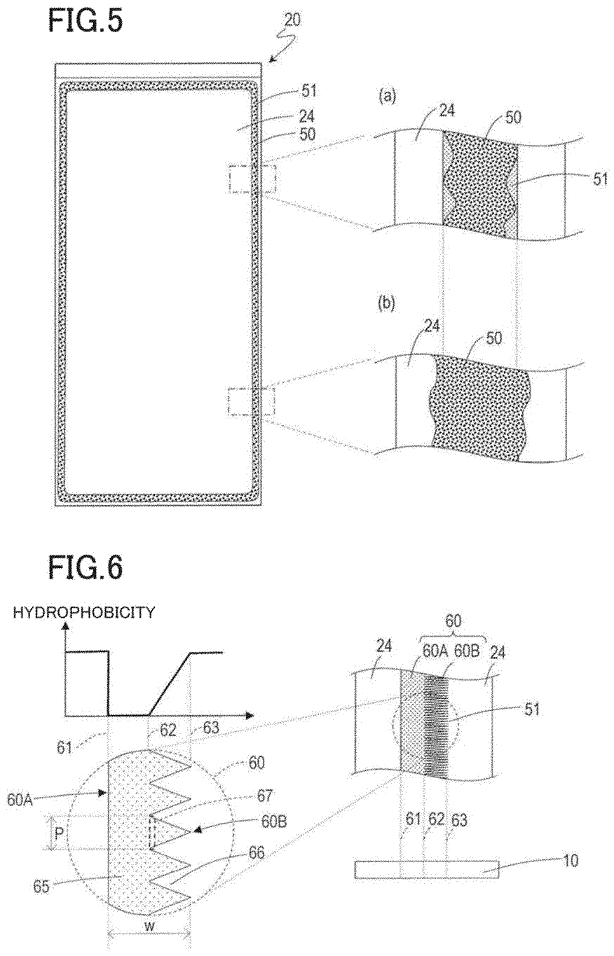

FIG. 5 is a plan view schematically illustrating the seal 50 formed in the sealing region 51 of the counter substrate 20.

Described here is a sealing region, of a conventional technique, that is less hydrophobic than the edge region. The sealing region is not provided with a hydrophobic film. In this Specification, a region without the hydrophobic film and less hydrophobic than the edge region is referred to as a “hydrophilic region.” In the hydrophilic sealing region 51 illustrated in FIG. 5, the counter electrode 22 is exposed. As shown in an illustration (b) in FIG. 5, depending on the position of the sealing material to be applied and the amount of the sealing material to be discharged in the hydrophilic sealing region 51, the sealing material could run out of a boundary between the second hydrophobic layer 24 and the sealing region 51 into a region of the second hydrophobic layer 24. In such a case, the volume of the clearance 40 decreases for the running sealing material. Meanwhile, as shown in an illustration in (a) in FIG. 5, when the sealing material is applied in a smaller amount than a desired one, for example, a gap could appear between the sealing material and the boundary of the second hydrophobic layer 24 and the sealing region 51. In such a case, the volume of the clearance 40 increases for the gap.

In the conventional technique, the sealing material could be excessively or insufficiently provided locally as can be seen, and the volume inside the cell is not constant and can vary. In particular, the sealing material is likely to be excessively or insufficiently provided locally when, for example, not a precise amount of the sealing material is discharged from the dispenser. If the discharge amount is insufficient, the sealing material fails to spread all across the sealing region. If the discharge amount is excessive, the sealing material inevitably runs into the region of the second hydrophobic layer 24. Taken into consideration variation in the position and discharge amount of the sealing material in manufacturing the counter electrode 20, desired is a technique to appropriately control the position in which the sealing material is applied so that the sealing material spreads to the boundary between the second hydrophobic layer 24 and the sealing region 51. In this Specification, not only the start position in which the sealing material is applied in the sealing region using the dispenser, but also the final position of the sealing material spreading in the sealing region with pressing force from both the TFT substrate 10 and the counter substrate 20 is also referred to as “a position in which the sealing material is applied.”

FIG. 6 illustrates the sealing region 51 including a hydrophilic region 60A and a hydrophobic angled region 60B.

A sealing region of at least one of the TFT substrate 10 and the counter substrate 20 in the EWOD according to the present disclosure includes the hydrophobic angled region 60B having a wettability gradient along the width of the sealing region 51. The wettability gradient increases in hydrophobicity toward an outer edge 63 of the sealing region 51. The wettability gradient (or the hydrophobicity gradient) represents a rate of change in hydrophobicity along the width of the sealing region 51. The hydrophobic angled region 60B provided to the sealing region 51 makes it possible to appropriately control the position in which the sealing material is applied.

In this embodiment, the hydrophobic angled region 60B is disposed in the sealing region 51 of the counter substrate 20 of the two substrates, and the sealing material is applied to the sealing region 51 of the counter substrate 20. Note that a sealing region of the TFT substrate 10 may be provided with a hydrophobic angled region, and the sealing material may be applied to the sealing region. Alternatively, sealing regions of the both substrates may be each provided with a hydrophobic angled region, and a sealing region of one of the substrates is coated with the sealing material.

FIG. 6 illustrates a graph showing an example of the wettability gradient along the width of the sealing region 51 of the counter substrate 20. The horizontal axis indicates a position along the width of the sealing region 51, and the vertical axis indicates hydrophobicity. The sealing region 51 includes the hydrophilic region 60A and the hydrophobic angled region 60B.

The hydrophilic region 60A is relatively lower in hydrophobicity than the second hydrophobic layer 24 that is an edge region. The hydrophilic region 60A includes a hydrophilic surface 65 hydrophobicity of which is relatively low. The hydrophilic region 60A is not provided with a hydrophobic layer. For example, in hydrophilic region 60A, the counter electrode 22 is exposed on the hydrophilic surface 65. The hydrophilic region 60A is in contact with an inner edge 61 of the sealing region 51. Hereinafter, the inner edge 61 of the sealing region 51 is referred to as a “boundary 61.” The hydrophobicity changes drastically (step-function-wise) in the inner edge 61 between the sealing region 51 and the second hydrophobic layer 24.

The hydrophobic angled region 60B includes: the hydrophilic surface 65 hydrophobicity of which is relatively low; and a hydrophobic surface 66 hydrophobicity of which is relatively high. When observed from the normal direction of the substrates, the hydrophobic angled region 60B is in contact with the outer edge 63 of the sealing region 51 and with the hydrophilic region 60A. Hereinafter, the boundary between the hydrophilic region 60A and the hydrophobic angled region 60B is referred to as a “boundary 62”, and the outer edge 63 of the sealing region 51 is referred to as a “boundary 63.” As seen in the second hydrophobic layer 24, the hydrophobic surface 66 is covered with a hydrophobic film. In the boundary 62, the hydrophilic surface 65 is continuous.

As an example, when observed from the normal direction of the substrates, the hydrophilic surface 65 can be shaped into a comb in the hydrophobic angled region 60B to taper toward the outer edge 63 of the sealing region 51. As an other example, when observed from the normal direction of the substrates, the hydrophilic surface 65 can be shaped into sparse or dense dots in the hydrophobic angled region 60B. For example, the hydrophilic surface 65, shaped into a comb and extending in a direction perpendicular to the width of the sealing region 51, has a pitch (length) P of approximately 0.1 mm. The sealing region 51 has a width W of approximately 1.5 mm. Here, the region 67 defining a unit of area is determined as a rectangular region indicated by a dashed line in FIG. 6. The length of the region 67 in a direction perpendicular to the width of the sealing region 51 corresponds to the pitch P.

A proportion of the hydrophilic surface 65 per unit of area, in a direction perpendicular to the width of the sealing region 51, decreases toward the boundary 63 of the sealing region 51. In other words, as the region 67 shifts to the boundary 63 of the sealing region 51, the proportion of the hydrophilic surface 65 per unit of area decreases. Thanks to such a feature, the hydrophobicity increases along the width of the sealing region 51 toward the boundary 63 of the sealing region 51. More specifically, the hydrophobicity increases from the boundary 61 with the hydrophilic region 60A toward the boundary 63 with the sealing region 51.

The hydrophobic angled region 60B in the boundary 63 of the sealing region 51 is substantially equal in hydrophobicity to the second hydrophobicity 24. Hence, the hydrophobicity is continuous in the boundary 63.

As illustrated in FIG. 6, the hydrophobicity preferably increases from the boundary 61 toward the boundary 63 in the sealing region 51. Such a wettability gradient causes the sealing material to easily run out of the boundary 63 of the sealing region 51. The sealing material running out of the boundary 63 of the sealing region 51 does not affect variation in volume of an active area. Moreover, the width of the hydrophobic angled region 60B along the width of the sealing region 51 is preferably greater than or equal to half, and smaller than or equal to two third, the width of all the sealing region 51. Such a feature makes it possible to control more precisely the position in which the sealing material is applied.

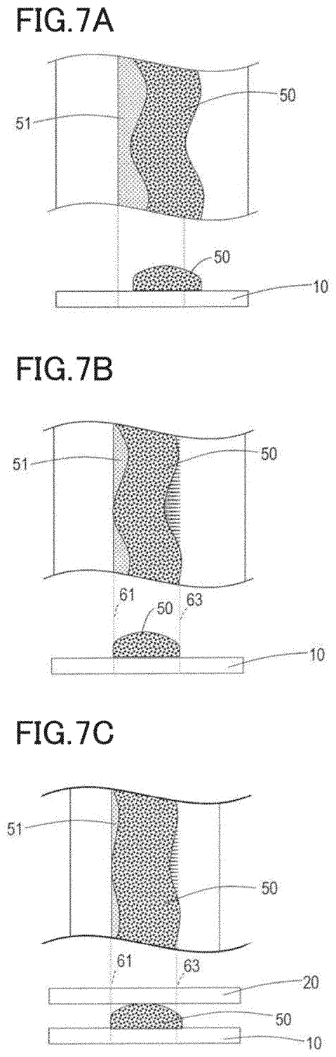

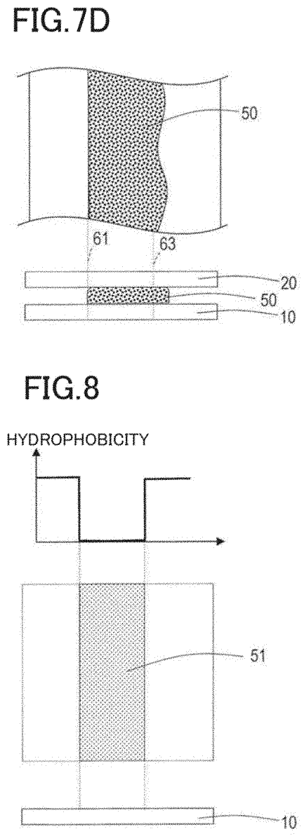

FIGS. 7A to 7D illustrate how a position in which a sealing material is applied can be controlled with the hydrophobic angled region 60B provided in the sealing region 51.

As illustrated in FIG. 7A, a position of the sealing material is assumed to be displaced out of the sealing region 51. In such a case, as illustrated in FIG. 7B, the sealing material moves (or runs) toward the center of the sealing region 51 in accordance with the wettability gradient whose hydrophobicity increases. Moreover, as illustrated in FIG. 7C, even if the sealing material receives pressing force generated when the TFT substrate 10 and the counter substrate 20 are attached together, the action of the wettability gradient reduces the spread of the sealing material. More specifically, as illustrated in FIG. 7D, in receiving the pressing force generated when the TFT substrate 10 and the counter substrate 20 are attached together, the sealing material is unlikely to spread toward the boundary 61, and is relatively likely to spread toward the boundary 63. That is, the wettability gradient keeps the sealing material from excessively spreading inside, and allows the sealing material, which used to run out of the boundary 61 into a region of the second hydrophobic layer 24, to run outside the boundary 63. As a result, the sealing material reaches the boundary 61 to which the sealing material is supposed to spread, and reduces the risk of creating a gap along the boundary 61. Such a feature makes it possible to reduce variation in volume of the active area.

With reference to FIGS. 8 to 13D, specifically described is how the hydrophobic angled region 60B provided to the sealing region 51 can control the position in which the sealing material is applied in the case where the sealing material is discharged either insufficiently or excessively from the dispenser, compared with a case where the hydrophobic angled region 60B is not provided (a comparative example).

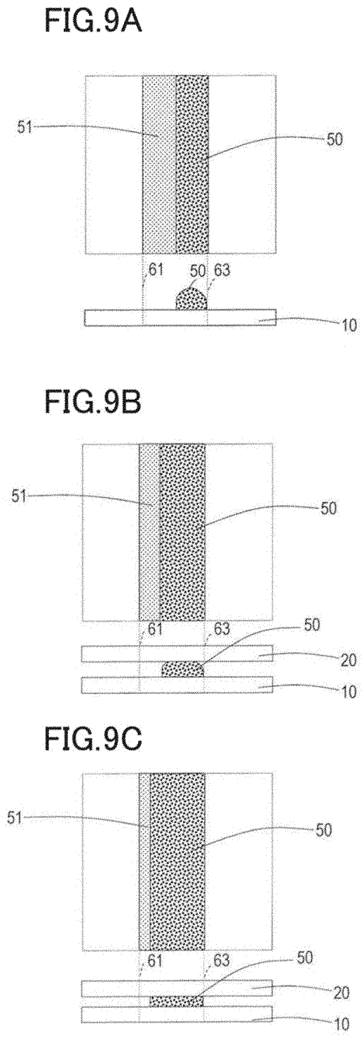

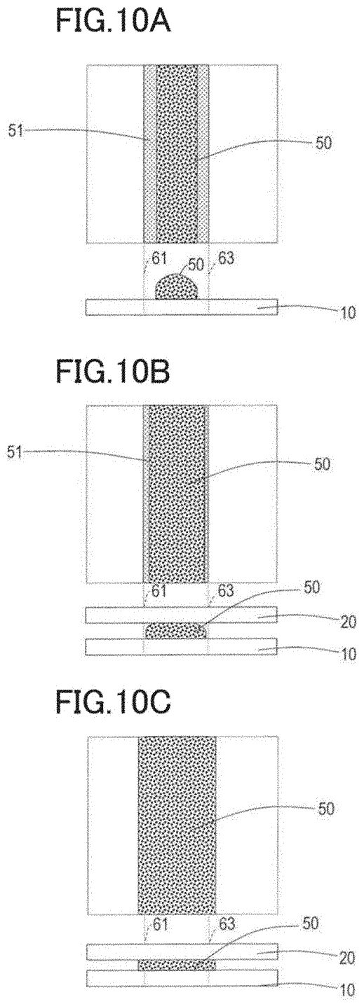

FIG. 8 is a drawing illustrating a wettability gradient of a sealing region according to a comparative example. FIGS. 9A to 9C are drawings illustrating a position in which the sealing material is applied according to the comparative example when the sealing material is discharged in small amount. FIGS. 10A to 10C. are drawings illustrating a position in which the sealing material is applied according to the comparative example when the sealing material is discharged in large amount.

In the comparative example, a hydrophobic film is not formed on all the sealing region 51. That is, the sealing region 51 is covered with a hydrophilic surface, and relatively low in hydrophobicity. As described before, the sealing material ideally spreads to, but does not exceed, the boundary 61 to which the sealing material is supposed to spread. Considered here is a case where the sealing material is applied, in a position illustrated in FIG. 9A, in an amount smaller than it is supposed to be. In such a case, the sealing material spreads to some extent toward the boundary 61 by the pressing force of the both the TFT substrate 10 and the counter substrate 20 as illustrated in FIG. 9B. However, as illustrated in FIG. 9C, the sealing material does not reach the boundary 61. As a result, a gap appears in the sealing region 51 along the boundary 61.

Considered here is an other case where the sealing material is applied, to a position illustrated in FIG. 10A (i.e., substantially a center of the sealing region 51), in an amount larger than it is supposed to be. In such a case, the sealing material spreads toward both of the boundaries 61 and 63 by the pressing force of the both the TFT substrate 10 and the counter substrate 20 as illustrated in FIG. 10B. As illustrated in FIG. 10C, the sealing material further receives the pressing force, and spreads toward both of the boundaries 61 and 63. As a result, the sealing material inevitably runs out of the boundary 61 and into the region of the second hydrophobic layer 24.

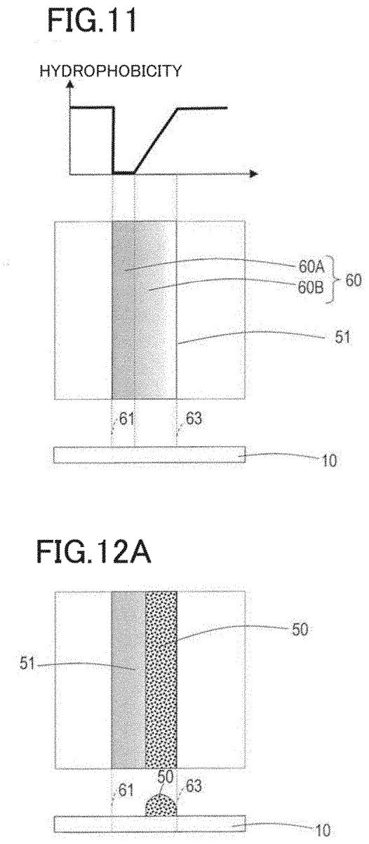

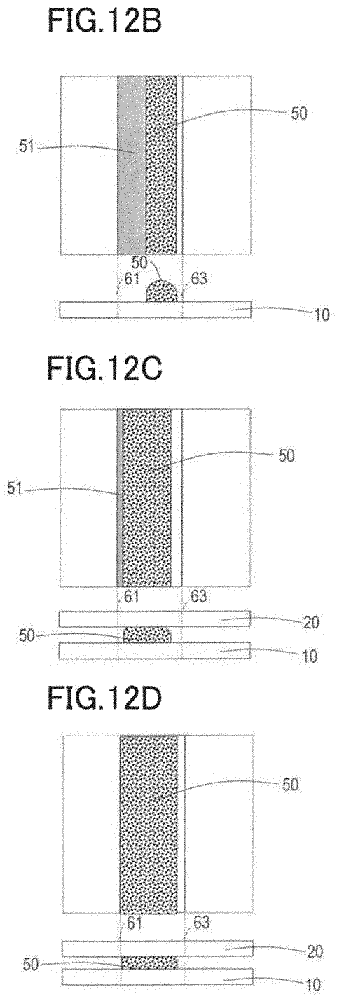

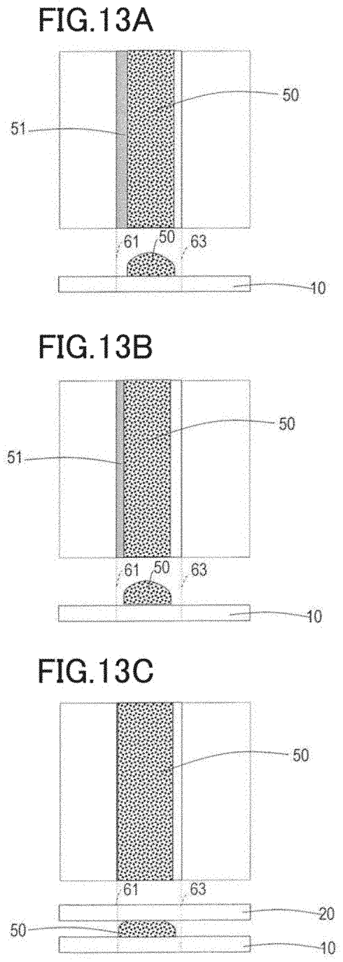

FIG. 11 is a drawing illustrating a wettability gradient of the sealing region 51 according to this embodiment. FIGS. 12A to 12D are drawings illustrating a position in which the sealing material is applied when the sealing material is discharged in small amount. FIGS. 13A to 13D are drawings illustrating a position in which the sealing material is applied when the sealing material is discharged in large amount.

The sealing region 51 in this embodiment includes the hydrophilic region 60A and the hydrophobic angled region 60B. The hydrophobic angled region 60B includes a wettability gradient whose hydrophobicity increases toward the boundary 63 of the sealing region 51. Considered here is a case where the sealing material is applied, in a position illustrated in FIG. 12A, in an amount smaller than it is supposed to be. In such a case, as illustrated in FIG. 12B, the wettability gradient of the hydrophobic angled region 60B causes the sealing material to move (or to run) toward the boundary 61. As can be seen, even if the position in which the sealing material is applied is away from the boundary 61, the wettability gradient allows the sealing material to run toward the boundary 61. As illustrated in FIG. 12C, the sealing material further spreads toward the boundary 61 by the pressing force of the TFT substrate 10 and the counter substrate 20. However, as illustrated in FIG. 12D, the sealing material is less likely to run out of the boundary 61 into the region of the second hydrophobic layer 24 even if receiving additional pressing force from the pressing force of the TFT substrate 10 and the counter substrate 20. As a result, unlike the comparative example, the gap is less likely to appear in the sealing region 51 along the boundary 61.

Considered here is an other case where the sealing material is applied, in a position illustrated in FIG. 13A, in an amount larger than it is supposed to be. In such a case, as illustrated in FIG. 13B, the wettability gradient of the hydrophobic angled region 60B causes the sealing material to move toward the boundary 61. As illustrated in FIG. 13C, the sealing material further spreads toward both of the boundaries 61 and 63 by the pressing force of the TFT substrate 10 and the counter substrate 20. Here, the wettability gradient is larger near the boundary 61 with the hydrophilic region 60A and is relatively smaller toward the boundary 63 with the hydrophobic angled region 60B. Hence, the sealing material is less likely to spread toward the boundary 61 with the sealing region 51, and is relatively likely to spread toward the boundary 63. As can be seen, redundant sealing material flows toward the boundary 63 whose hydrophobicity is relatively low. Hence, as illustrated in FIG. 13D, the gap is less likely to appear in the sealing region 51 along the boundary 61. Note that the sealing material spreading out of the boundary does not affect variation in volume of the active area.

As can be seen, in this embodiment, the wettability gradient can control the position in which the sealing material is applied in the case where the sealing material to be applied is discharged either in small amount or large amount. More specifically, the sealing material can spread to the boundary 61 to which the sealing material is supposed to spread, without running into the region of the second hydrophobic layer 24.

FIG. 14 is a drawing illustrating a wettability gradient of the sealing region 51 including an other hydrophobic angled region 60C different from the hydrophobic angled region 60B.

The sealing region 51 can further include a hydrophobic angled region 60C in contact with the boundary 61 and with the hydrophilic region 60A in the sealing region 51. That is, the hydrophobic angled region 60C is positioned between the boundary 61 and the hydrophilic region 60A. The hydrophobic angled region 60C includes a wettability gradient along the width of the sealing region 51. The wettability gradient increases in hydrophobicity toward the boundary 61 of the sealing region 51. The wettability gradient of the hydrophilic region 60C is larger than the wettability gradient of the hydrophobic angled region 60B. The hydrophobic angled region 60C in the boundary 61 of the sealing region 51 is substantially equal in hydrophobicity to the second hydrophobic layer 24. That is, the hydrophobicity is continuous in the boundary 61 of the sealing region 51.

The sealing region 51 further includes the hydrophobic angled region 60C, making it possible to control more precisely the position in which the sealing material is applied. Moreover, the wettability gradient is larger in the hydrophobic angled region 60C than in the hydrophobic angled region 60B. Such a feature achieves an advantageous effect that redundant sealing material readily runs toward the boundary 63 whose hydrophobicity is relatively low, making it possible to reduce variation in volume of the active area.

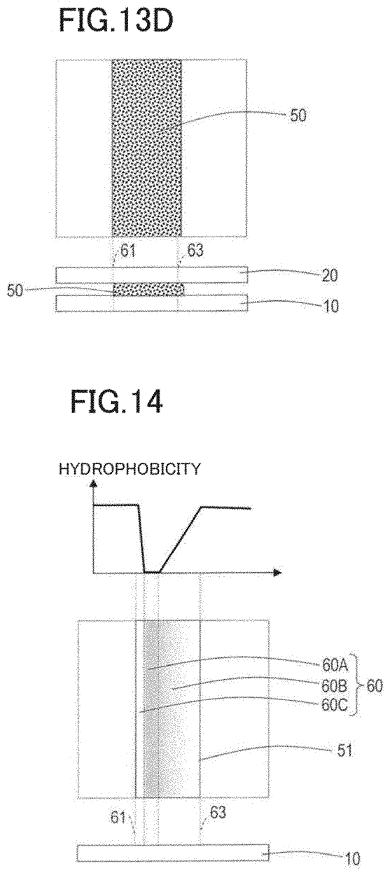

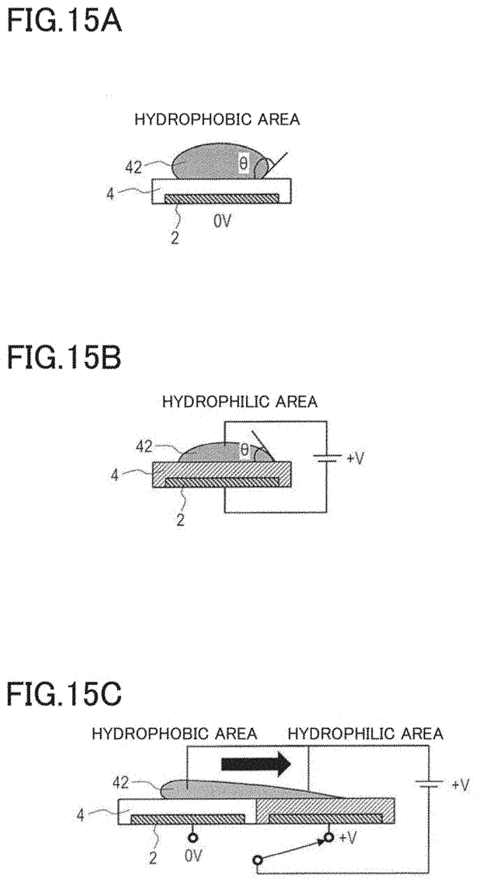

Described here is a principle in which the droplet 42 can be moved by electrowetting, with reference to FIGS. 15A to 15C.

FIGS. 15A to 15C are schematic views illustrating the principle of how the electrowetting can move the droplet 42.

As described before, the electrowetting is a phenomenon in which, when an electric field is applied to the droplet 42 on a hydrophobic dielectric layer (a hydrophobic layer) 4 provided on an electrode 2, a contact angle θ of the droplet 42 with respect to the dielectric layer 4 changes. As illustrated in FIG. 15A, when no voltage is applied, the region on the electrode 2 can become hydrophobic (i.e., θ>90°, and hereinafter referred to as a “hydrophobic area”). As illustrated in FIG. 15B, when a predetermined voltage (+V) is applied, the region on the electrode 2 can become hydrophilic (i.e., θ<90°, and hereinafter referred to as a “hydrophilic area”). Hence, as illustrated in FIG. 15C, when the hydrophobic area and the hydrophilic area lay side by side, the droplet 42 in the hydrophobic area moves to the hydrophilic area. When this motion occurs continuously, the droplet 42 can be moved freely in the active region.

2. Method for Manufacturing AM-EWOD 100

Described here is an example of a method for manufacturing the AM-EWOD 100. Note that the TFT circuit 16 shall not be limited to the one described below as an example. Alternatively, the TFT circuit 16 may be a known TFT circuit.

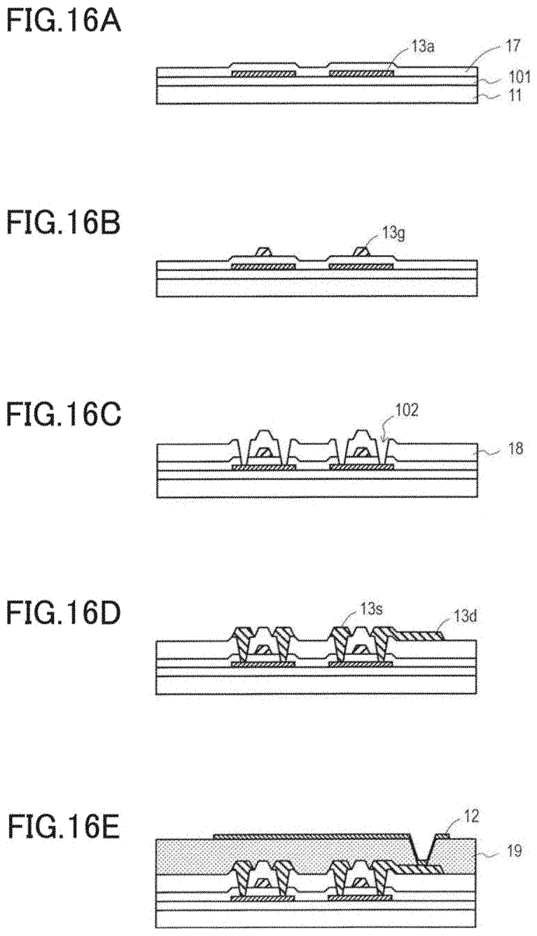

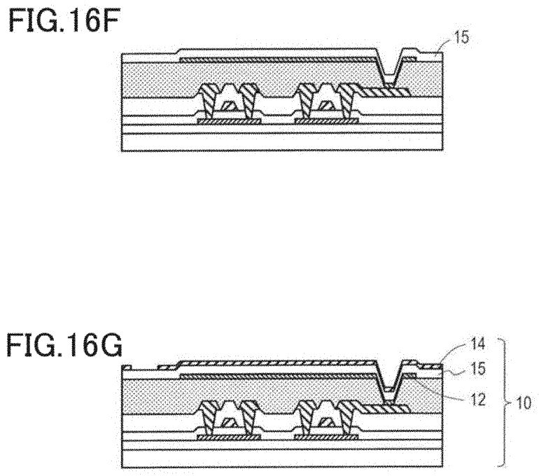

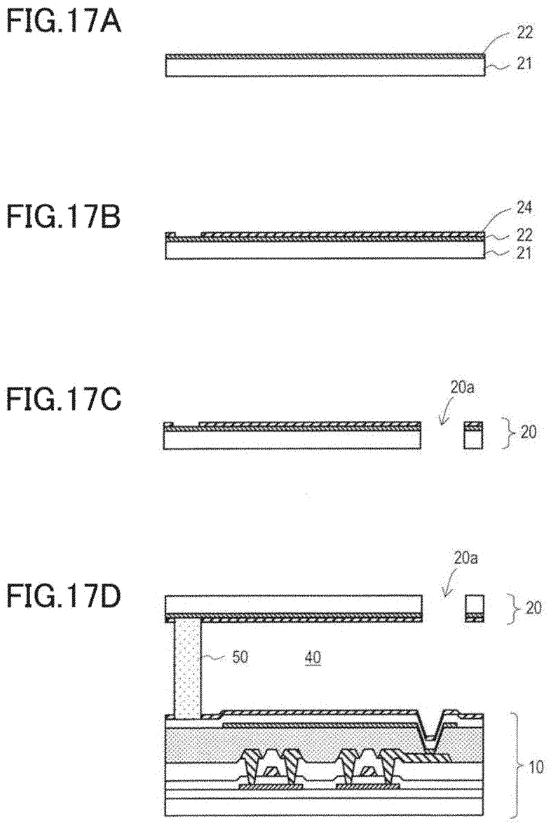

With reference to FIGS. 16A to 17D, described here is an example of a method for manufacturing the AM-EWOD 100 according to this embodiment.

FIGS. 16A to 16G are cross-sectional views schematically illustrating an example of a method for manufacturing the TFT substrate 10 included in the AM-EWOD 100.

First, as illustrated in FIG. 16A, for example, a buffer layer 101 is optionally formed on the glass substrate 11. The buffer layer 101 may be a single layer selected from a group of an SN layer, an SiO₂ layer, and an SiON layer, or a multilayer made of two or more of the layers selected from the group. The buffer layer 101 has a thickness ranging, for example, from 100 nm to 300 nm.

On the buffer layer 101, for example, an amorphous silicon film is formed in a thickness ranging from approximately 20 nm to 100 nm. After that, the amorphous silicon film is crystallized to be a polysilicon film. The polysilicon film is patterned in, for example, photolithography including dry etching, and the semiconductor layer 13a is obtained. As the semiconductor layer 13a, for example, continuous grain silicon (CGS) is preferably used.

On the semiconductor layer 13a, the gate insulating layer 17 is formed. The gate insulating layer 17 is, for example, an SiN layer, an SiO₂ layer, or a multilayer including an SiN layer and an SiO₂ layer. The thickness of the gate insulating layer 17 ranges, for example, approximately from 50 nm to 200 nm.

Next, as illustrated in FIG. 16B, formed on the gate insulating layer 17 is the gate electrode 13g. The gate electrode 13g is formed of a metal layer made of, for example, W, Mo, and Al and patterned in photolithography. The gate electrode 13g has a thickness ranging, for example, from 100 nm to 400 nm. In order to enhance sealability and improve contact resistance, the gate electrode 13g may be made of a multilayer including W/Ta, MoW, Ti/Al, Ti/Al/Ti, and Al/Ti, or of an alloy layer containing such metals.

Next, as illustrated in FIG. 16C, the interlayer insulating layer 18 is formed. The interlayer insulating layer 18 is, for example, an SiN layer, an SiO₂ layer, an SiON layer, or a multilayer including these layers. The interlayer insulating layer 18 has a thickness ranging from 500 nm to 900 nm, for example. A contact hole 102 is formed by patterning in photolithography.

Next, as illustrated in FIG. 16D, the source electrode 13s and the drain electrode 13d are formed. The source electrode 13s and the drain 13d are formed of a metal layer made of, for example, Al, and Mo and patterned in photolithography. The source electrode 13s and the drain electrode 13d have a thickness ranging, for example, from 200 nm to 400 m. In order to enhance sealability and improve contact resistance, the source electrode 13s and the drain electrode 13d may be made of a multilayer including Ti/Al, Ti/Al/Ti, Al/Ti, TiN/Al/TiN, Mo/Al, Mo/Al/Mo, Mo/AlNd/Mo, MoN/Al/MoN, and AI/Ti. or of an alloy layer containing such metals.

This is how a TFT to be connected to a unit electrode 12 is prepared. Along with the TFT, an other TFT to be included in the gate driver 72 and the source driver 73 (see FIG. 3) may be prepared as necessary. The TFT 13 shall not be limited to the one in the above example. Alternatively, the TFT 13 may be made of a known material and by a known manufacturing method.

Next, as illustrated in FIG. 16E, the interlayer insulating layer 19 is formed. The interlayer insulating layer 19 is made of a photosensitive resin material, and formed in photolithography. On the unit electrode 19, the unit electrodes 12 are formed. An InZnO film having a thickness ranging from 50 nm to 150 nm is deposited by sputtering and patterned in photolithography. This is how the unit electrodes 12 are formed. Here, the sputtering is performed preferably at a temperature of 300° C. or below, and more preferably at a temperature of 250° C. or below in order to deposit an amorphous InZnO film. Whether the formed amorphous InZnO film is desirable can be checked by X-ray diffraction (XRD). The unit electrodes 12 may be made of, for example, ITO, IZO, or ZnO.

Next, as illustrated in FIG. 16F, the dielectric layer 15 is formed. The dielectric layer 15 may be a single layer selected from a group of an SiN layer, an SiO₂ layer, and an SiON layer, or a multilayer made of two or more of the layers selected from the group. The dielectric layer 15 is formed of, for example, an SiN layer. The amount of hydrogen contained in the SiN layer may be controlled by any given known technique. In an example of the control, silane, ammonia, and nitrogen are used as materials, and the concentration of ammonia is controlled by the plasma chemical vapor deposition (CVD) (see, for example, Japanese Patent No. 3045945).

Although not shown, the SiN layer is patterned in photolithography so that an opening is formed to expose, for example, the on-board terminal 71 (see FIG. 3).

Next, as illustrated in FIG. 16G, the first hydrophobic layer 14 is formed. The first hydrophobic layer 14 is, for example, a fluoropolymer layer ranging from 30 nm to 100 nm in thickness. Preferably, the fluoropolymer chemically binds with a surface of an oxide conductive layer, and is, for example, terminally functionalized. Examples of the terminal functional group includes —Si—(OR)n, —NH—Si—(OR)n, —CO—NH—Si—(OR)n, and —COOH with n being 1 to 3. Moreover, along with the fluoropolymer, a silane coupling agent and a fluoro primer may be used. As an example of the fluoropolymer, Cytop (Registered) manufactured by AGC Inc. is preferably used.

The fluoropolymer layer is formed of a fluoropolymer solution (containing a fluorine-based solvent) and by a known technique such as photolithography, dip-coating, slit-coating, and printing. In order to further remove the solvent and/or to further stabilize the fluoropolymer, the fluoropolymer layer is preferably subjected to heat treatment at a temperature approximately ranging from 170° C. to 200° C. for example. Furthermore, before formation of the fluoropolymer layer, treatment with a silane coupling agent and a fluoro primer may be provided. In the above process, lift-off may be used as appropriate instead of photolithography.

In the process forming the first hydrophobic layer 14, the sealing region 51 is formed on the TFT substrate 10 to surround the first hydrophobic layer 14. For example, a resist is patterned in photolithography, and then a fluoropolymer film is formed on all the TFT substrate 10. After that, the resist is removed together with the fluoropolymer layer (a hydrophobic layer), and the sealing region 51 is formed. Note that, in this embodiment, the sealing region 51 of the TFT 10 is not provided with a hydrophobic angled region. Alternatively, as described later, the sealing region 51 of the counter substrate 20 is provided with a hydrophobic angled region having a desired wettability gradient. Note that the hydrophobic angled region may be provided to both the TFT 10 and the counter substrate 20.

Hence, the TFT substrate 10 is obtained.

Now, manufacturing methods are described with reference to FIGS. 17A to 17D. FIGS. 17A to 17C are cross-sectional views schematically illustrating an example of a method for manufacturing the counter substrate 20 included in the AM-EWOD 100. FIG. 17D is a cross-sectional view schematically illustrating an example of a manufacturing method in which the TFT substrate 10 and the counter substrate 20 are attached together.

As illustrated in FIG. 17A, for example, the counter electrode 22 is formed on a glass substrate 21. The counter electrode 22 is formed substantially on all the glass substrate 21. The counter electrode 22 is formed of a transparent oxide conductive layer such as an ITO layer, an InZnO layer, or a ZnO layer. The dielectric layer 22, having a thickness ranging from 50 nm to 150 nm, for example, is formed by sputtering. Although not shown, an alignment marking required for a treatment in a downstream step is made in photolithography. After the TFT substrate 10 and the counter substrate 20 are attached together, an electrode material, found in a position at which the substrates are cut into pieces for each module, may simultaneously be removed. The removal of the electrode material can reduce the risk of faulty conduction between the substrates.

Next, as illustrated in FIG. 17B, the second hydrophobic layer 24 is formed. The second hydrophobic layer 24 is formed with the same technique as that forming the first hydrophobic layer 14 described with reference to FIG. 16G. In the process forming the second hydrophobic layer 24, the sealing region 51 is formed on the counter substrate 20 to surround the second hydrophobic layer 24. For example, a fluoropolymer film is formed on all the counter substrate 20. After that, in order to enhance wettability of a resist, a surface of the fluoropolymer film is treated with, for example, an argon plasma. After that, the resist is patterned in photolithography, using a photomask having a pattern corresponding to a shape of the hydrophobic surface 66 on the hydrophobic angled region 60B. After that, the fluoropolymer is etched with an oxygen plasma and the resist is removed, so that the sealing region 51 is formed to include the hydrophobic angled region 60B having a desired wettability gradient.

Next, as illustrated in FIG. 17C, the through hole 20a for injecting the droplet 42 is formed in the counter substrate 20. The through hole 20a can be formed by such known glass processing techniques as machine processing using a drill, laser processing, and wet etching. The through hole 20a has a diameter approximately ranging from 1 mm to 5 mm, and the diameter is selected as appropriate depending on how to inject the droplet 42 and/or how much the droplet 42 is injected.

Hence, the counter substrate 20 is obtained.

Next, as illustrated in FIG. 17D, the TFT substrate 10 and the counter substrate 20 are attached together. For example, a sealing material is applied with a dispenser along the sealing region 51 on an outer edge of the counter substrate 20. An example of the sealing material is a mixture of a thermosetting resin and spacer (e.g., glass or plastic beads having a diameter ranging from 200 μm to 300 μm). The sealing material can reliably provide a cell gap (a clearance between the substrates) of the flow passage 40. Moreover, when the sealing material is applied, the transfer (the transfer electrode) 74 formed of, for example, a conductive paste is provided to an edge region of the counter substrate 20 in order to electrically connect the counter electrode 22 to the on-board terminal 71 of the TFT substrate 10.

The TFT substrate 10 and the counter substrate 20 are attached together, with the sealing material applied on the counter substrate 20 and between the substrates. The sealing material is, for example, thermally set. Here, the first hydrophobic layer 14 and the second hydrophobic layer 24 face each other, and the clearance (the flow passage) 40; that is, a uniform cell gap, is defined between the layers.

Hence, the AM-EWOD 100 is obtained.

Finally, the TFT substrate 10 and the counter substrate 20 are divided into devices (or modules) by dicing or laser processing. The through hole 20a is preferably covered with, for example, film before the substrates are divided into devices. The film covering the through hole 20a can appropriately keep glass cullet, cleaning water, and sublimate from entering the cell when the substrates are divided.

The present disclosure can be widely applicable to electrowetting devices. The electrowetting device according to an aspect of the present invention is preferably used for devices to carry out bio-analyses such as gene analyses and chemical reactions.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An electrowetting device, comprising:
an electrode substrate including a first substrate, a plurality of first electrodes formed above the first substrate, a dielectric layer formed on the first electrodes, and a first hydrophobic layer formed on the dielectric layer;
a counter substrate disposed across a predetermined clearance from the electrode substrate, and including a second substrate, a second electrode formed on the second substrate, and a second hydrophobic layer formed on the second electrode; and
a seal attaching the electrode substrate and the counter substrate together, and defining the predetermined clearance between the first hydrophobic layer and the second hydrophobic layer,
the electrode substrate and the counter substrate each including a sealing region having a predetermined width and surrounding the first hydrophobic layer and the second hydrophobic layer when observed from a normal direction of the electrode substrate and the counter substrate, the seal being formed along the sealing region of each of the electrode substrate and the counter substrate, and
the sealing region of at least one of the electrode substrate and the counter substrate includes a hydrophobic angled region having a wettability gradient along the predetermined width of the sealing region and a width of a hydrophilic region, the wettability gradient increasing in hydrophobicity toward an outer edge of the sealing region.

2. The electrowetting device according to claim 1, wherein
the hydrophobic angled region includes a hydrophilic surface hydrophobicity of which is relatively low, and a hydrophobic surface hydrophobicity of which is relatively high, and
a proportion of the hydrophilic surface per unit of area, in a direction perpendicular to the predetermined width of the sealing region, decreases toward the outer edge of the sealing region.

3. The electrowetting device according to claim 2, wherein
when observed from the normal direction of the electrode substrate and the counter substrate, the hydrophilic surface is shaped into a comb in the hydrophobic angled region to taper toward the outer edge of the sealing region.

4. The electrowetting device according to claim 2, wherein
when observed from the normal direction of the electrode substrate and the counter substrate, the hydrophilic surface is shaped into dots in the hydrophobic angled region.

5. The electrowetting device according to claim 1, wherein
when observed from the normal direction of the electrode substrate and the counter substrate, the hydrophobic angled region is in contact with the outer edge of the sealing region.

6. The electrowetting device according to claim 5, wherein
when observed from the normal direction of the electrode substrate and the counter substrate, the hydrophobic angled region is further in contact with the hydrophilic region, the hydrophobic angled region having the wettability gradient increasing in hydrophobicity from a boundary with the hydrophilic region toward the outer edge of the sealing region.

7. The electrowetting device according to claim 6, wherein
the hydrophobic angled region has the wettability gradient continuously increasing in hydrophobicity from the boundary with the hydrophilic region toward the outer edge of the sealing region.

8. The electrowetting device according to claim 6, wherein
the hydrophilic region is in contact with an inner edge of the sealing region.

9. The electrowetting device according to claim 8, wherein
the hydrophobic angled region has a width along the predetermined width of the sealing region, the width being greater than or equal to half, and smaller than or equal to two third, the predetermined width of all the sealing region.

10. The electrowetting device according to claim 6, wherein
the sealing region includes an other hydrophobic angled region different from the hydrophobic angled region, the other hydrophobic angled region being in contact with an inner edge and with the hydrophilic region of the sealing region, and
the other hydrophobic angled region has a wettability gradient along the predetermined width of the sealing region, the wettability gradient increasing in hydrophobicity toward the inner edge of the sealing region.

11. The electrowetting device according to claim 10, wherein
the wettability gradient of the other hydrophilic angled region is larger than the wettability gradient of the hydrophobic angled region.

12. The electrowetting device according to claim 6, wherein
the sealing region of the counter substrate includes the hydrophilic region and the hydrophobic angled region, and
the hydrophobic angled region in the outer edge of the sealing region is substantially equal in hydrophobicity to the second hydrophobic layer.

13. The electrowetting device according to claim 6, wherein
the sealing region includes an other hydrophobic angled region different from the hydrophobic angled region, the other hydrophobic angled region being in contact with an inner edge and with the hydrophilic region of the sealing region,
the other hydrophobic angled region has a wettability gradient along the predetermined width of the sealing region, the wettability gradient increasing in hydrophobicity toward the inner edge of the sealing region,
the sealing region of the counter substrate includes the hydrophilic region and the hydrophobic angled region, and
the hydrophobic angled region in the outer edge of the sealing region is substantially equal in hydrophobicity to the second hydrophobic layer.

14. The electrowetting device according to claim 13, wherein
the other hydrophobic angled region in the inner edge of the sealing region is substantially equal in hydrophobicity to the second hydrophobic layer.

15. The electrowetting device according to claim 1, wherein
the first electrodes are a group of electrodes arranged in a matrix, and
the electrode substrate further includes a plurality of thin-film transistors (TFTs) connected to the first electrodes.
